(19) United States
(12) Patent Application Publication
(10) Pub. No.: US 2018/0355939 A1
(43) Pub. Date: Dec. 13, 2018

(54) Vibration Damper For A Motor Vehicle

(71) Applicant: ZF Friedrichshafen AG, Friedrichshafen (DE)

(72) Inventors: Bernd ZEISSNER, Volkach (DE); Thomas MANGER, Wasserlosen (DE)

(73) Assignee: ZF Friedrichshafen AG, Friedrichshafen (DE)

(21) Appl. No.: 15/781,288

(22) PCT Filed: Nov. 8, 2016
(86) PCT No.: PCT/EP2016/076900

§ 371 Date: Jun. 4, 2018

(30) Foreign Application Priority Data
Dec. 10, 2015 (DE) 10 2015 224 811.9

(51) Int. Cl. F16F 9/32

(52) U.S. Cl. CPC F16F 9/325; F16F 2230/0005; F16F 9/3271; F16F 9/3257

(57) ABSTRACT

A vibration damper for a motor vehicle includes an outer cylinder tube and an assembly unit (14). The assembly unit has a closure package through which a piston rod extends, an inner cylinder tube of the vibration damper within which a piston fastened to the piston rod is axially movably arranged, and a choke valve which are fixedly connected to one another. The choke valve is arranged axially at one side at the inner cylinder tube and the closure package is arranged axially at the other side at the inner cylinder tube. The assembly unit is arranged inside of the outer cylinder tube, and the assembly unit is fastened exclusively in a fastening area of the closure package to the outer cylinder tube.

### PRIORITY CLAIM

This is a U.S. national stage of application No. PCT/EP2016/076900, filed on Nov. 8, 2016. Priority is claimed on the following application: Country: Germany, Application No.: 10 2015 224 811.9, filed: Dec. 10, 2015, the content of which is/are incorporated herein in its entirety by reference.

### FIELD OF THE INVENTION

The present invention is directed to a vibration damper for a motor vehicle.

### BACKGROUND OF THE INVENTION

A vibration damper in monotube-type construction with a damping valve device arranged radially outwardly at an outer damper tube is disclosed in U.S. Pat. No. 4,650,042. An inner tube is inserted into the vibration damper for controlling this damping valve device. However, this also complicates assembly of the vibration damper.

Therefore, it is an object of the present invention to provide a vibration damper with a valve arranged radially at the damper tube which can be assembled simply, quickly and economically with respect to cost, labor and time.

### SUMMARY OF THE INVENTION

The vibration damper of the present invention has an outer cylinder tube which is closed at its axial end via a damper base. The vibration damper also has a gas piston and an assembly unit. The assembly unit is arranged inside the outer cylinder tube, in particular is inserted axially into the outer cylinder tube. The assembly unit comprises a closure package, an inner cylinder tube of the vibration damper, a choke valve, a piston rod and a piston. In addition, the assembly unit has a sealing element, in particular a sealing ring. The choke valve, the inner cylinder tube and the closure package are arranged in that axial order so as to be fixedly connected to one another. The piston is fastened to the piston rod such that the piston can move freely axially within the inner cylinder tube. The piston rod extends axially through the closure package. The closure package is arranged at the vibration damper on the axially opposite side of the damper base and closes the vibration damper so as to be tight against fluid. Further, the sealing element is fastened radially outwardly at the inner cylinder tube. An annular hollow cylindrical space is formed radially between the outer cylinder tube and the inner cylinder tube and is divided by the sealing element in a fluid-tight manner into two hollow cylindrical spaces in order to allow damping medium to be supplied to and removed from a damping valve device. Orifices which allow a flow of damping medium induced by piston movement out of the work spaces of the inner cylinder into the hollow cylindrical spaces, and vice versa, are formed at the inner cylinder tube. The damping valve device is arranged, particularly fastened or flanged, radially outwardly at the outer cylinder tube. In addition, the choke valve allows damping medium to flow into or out of a compensation space in which the gas piston operates. In particular, this allows a compensation by the damping medium displaced by the piston rod.

The assembly unit can be completely assembled already before final assembly of the vibration damper. In this case, it is possible during assembly to insert the assembly unit in its entirety into the outer cylinder tube and fasten it to the outer cylinder tube. A fastening area is formed at the closure package of the assembly unit by means of which the assembly unit is fixedly connected to the outer cylinder tube. The assembly unit is fastened to the outer cylinder tube advantageously exclusively through the fastening area. Accordingly, a simple and fast final assembly of the vibration damper is made possible by the preassembly of the assembly unit. Further, the closure package, the inner cylinder tube and the choke valve are fixedly connected to one another. Therefore, a beading which would serve to axially support the assembly unit can be dispensed with at the outer cylinder tube in the area of the choke valve. Further, accordingly, the assembly unit is arranged inside the outer cylinder tube so as to be free from stresses.

In one constructional variant, the fastening area of the assembly unit of the assembly unit is arranged at an axial end region of the outer cylinder tube and is fastened to this axial end region of the outer cylinder tube.

As has already been mentioned, this makes possible a simple final assembly of the vibration damper in which the quantity of required assembly steps is reduced to a minimum. The fastening area is advantageously arranged at the side of the outer damper tube opposite the damper base.

It is further suggested that a groove is formed at the fastening area of the closure package. This is advantageously formed at the closure package over the entire circumference. In this way, the assembly unit is securely and fixedly fastened to the outer cylinder tube by crimping the outer cylinder tube.

The assembly unit is advantageously fastened to the outer cylinder tube by crimping or rolling of the outer cylinder tube at the fastening area of the closure package.

It is further suggested that the crimping of the outer cylinder tube engages in the groove of the fastening area. In this regard, reference is made to the foregoing description.

In a particularly advantageous manner, the inner cylinder tube is fixedly arranged at the choke valve and/or at the closure package by screwing, gluing, rolling, welding or crimping.

Accordingly, it is possible for the assembly unit to be securely mounted through the combined use of one or more of these connection possibilities. This also obviates a supporting bead at the outer cylinder tube in the region of the choke valve during final assembly.

In a further constructional variant, a damping valve device arranged radially outwardly at the outer cylinder tube is arranged free from engagement at the outer cylinder tube.

In this case, the damping valve device is arranged entirely outside of the outer cylinder tube and accordingly does not engage in the outer cylinder tube. The operative connection of the damping valve device to the piston is brought about in particular through orifices which are arranged at the outer cylinder tube. As a result of this construction of the outer cylinder tube and the associated arrangement of the damping valve device, the outer cylinder tube is formed so as to be continuously circular at its inner surface, at least for the length of the assembly unit. Therefore, the assembly unit can be completely preassembled and can be inserted into the outer cylinder tube and subsequently fastened therein completely and in one work step without difficulty during final assembly. In so doing, as has already been mentioned, it is advantageous that only the arrangement of a crimp is required.

### BRIEF DESCRIPTION OF THE DRAWINGS

The vibration damper and the assembly unit according to the invention are described in the following in more detail and by way of example referring to the accompanying FIGURE.

### DETAILED DESCRIPTION OF THE PRESENTLY PREFERRED EMBODIMENTS

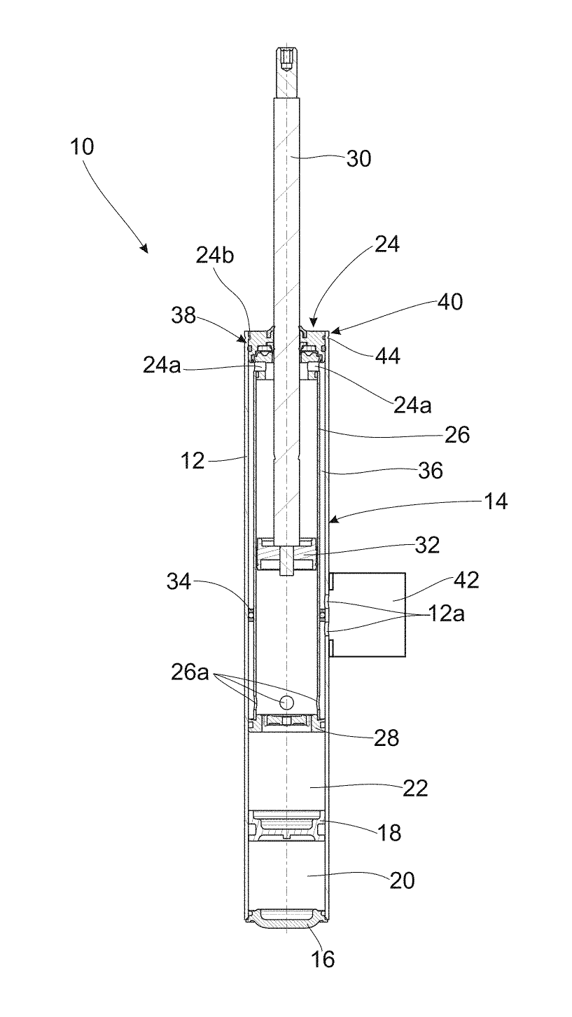

A vibration damper 10 is shown in FIG. 1. The vibration damper 10 comprises an outer cylinder tube 12 and an assembly unit 14. The outer cylinder tube 12 is closed at one axial end so as to be tight against fluid by a damper base 16. The assembly unit 14 is arranged at the axial end of the outer cylinder tube 12 opposite the damper base 16 and, during assembly, is inserted particularly axially into the outer cylinder tube 12 and fastened thereto. The assembly unit 14 is arranged inside of the outer cylinder tube 12 such that the latter terminate planar to one another.

Further, a gas dividing piston 18 which separates a gas space 20 from a work space 22 filled with oil is formed inside the outer cylinder tube 12 axially between the damper base 16 and the assembly unit 14.

The assembly unit 14 comprises a closure package 24, an inner cylinder tube 26, a choke valve 28, a piston rod 30, a piston 32 and a seal element 34. The inner cylinder tube 26 of the vibration damper which is associated with the component group of the assembly unit 14 is fixedly connected to the closure package 24 and is fixedly connected to the choke valve 28. For example, the latter may be screwed together, glued, rolled, welded or also connected to one another by arranging a crimp. The piston rod extends through the closure package 24 in axial direction so that the piston 32 which is fixedly connected to the piston rod 30 is constructed so as to be axially moveable within the inner cylinder tube 26. The closure package 24 seals the vibration damper 10 at the axial end thereof so as to be tight against fluid.

During an axial movement of the piston 32 within the inner cylinder tube 26, a damping medium is displaced or flushed out through orifices 26a at the inner cylinder tube 26 and through orifices 24a at the closure package 24 into a hollow cylindrical space 36 which is formed between the outer cylinder tube 12 and the inner cylinder tube 26. The hollow cylindrical space 36 is divided, once again in a fluid-tight manner, by the sealing element 34 which is fastened to the inner cylinder tube 26. In this way, the damping medium is guided through orifices 12a at the outer cylinder tube 12 through a damping valve device 42 which is shown schematically. This damping valve device 42 is fastened radially outwardly to the outer cylinder tube 12. The damping valve device 42 is arranged exclusively radially outside of the outer cylinder tube 12 and does not engage therein. An operative connection between the work space 22 and the damping valve device 42 is based chiefly on the orifices 12a. This makes it possible to completely preassemble the assemble unit 14 and to insert it into the outer cylinder tube in one work step. The choke valve 28 allows a compensation of damping medium between the work spaces based on the displacement action of the piston rod 30 during stroke movements.

The assembly unit 14 can be preassembled and introduced as an entirety into the vibration damper. In this case, the assembly unit 14 is inserted axially into the outer cylinder tube 12 and is fixedly connected to the outer cylinder tube 12 in a fastening area of the closure package 24. The fastening area 38 has an annularly circumferentially extending groove 24b at the closure package 24. This annularly circumferentially extending groove 24b is filled by a crimp of the outer cylinder tube 14 at the axial end area thereof. The fastening of the assembly unit 14 to the outer cylinder tube 12 is brought about by the crimp 44. The end of the assembly unit 14 axially opposite the closure package 24 is advantageously arranged axially in the first cylinder tube 12 so as to be free from force. Further, an additional crimping in the region of the choke valve 28 to enable a support of the assembly unit 14 can be obviated in this way.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-7. (canceled)

8. A vibration damper for a motor vehicle comprising:
an outer cylinder tube;
an assembly unit comprising a closure package having a fastening area;
a piston rod extending through the closure package;
an inner cylinder tube and a piston fastened to the piston rod and axially movably arranged within the inner cylinder tube;
a choke valve; the assembly unit, the inner cylinder tube and the choke valve fixedly connected to one another; the choke valve arranged axially at one side at the inner cylinder tube and the closure package arranged axially at another side at the inner cylinder tube;
the assembly unit arranged inside the outer cylinder tube; and
the assembly unit fastened exclusively in the fastening area of the closure package to the outer cylinder tube.

9. The vibration damper according to claim 8, wherein the fastening area of the assembly unit is arranged at an axial end region of the outer cylinder tube and is fastened to the axial end region of the outer cylinder tube.

10. The vibration damper according to claim 8, further comprising a groove formed at the fastening area of the closure package.

11. The vibration damper according to claim 8, wherein the assembly unit is fastened to the outer cylinder tube by crimping or rolling the outer cylinder tube at the fastening area of the closure package.

12. The vibration damper according to claim 11, wherein the crimp of the outer cylinder tube engages in a groove of the fastening area.

13. The vibration damper according to claim 8, wherein the inner cylinder tube is fastened to the choke valve and/or to the closure package by screwing, gluing, rolling, welding or crimping.

14. The vibration damper according to claim 8, further comprising a damping valve device arranged radially outwardly at the outer cylinder tube and arranged free from engagement at the outer cylinder tube.
